(19) United States
(12) Patent Application Publication
(10) Pub. No.: US 2010/0070342 A1
(43) Pub. Date: Mar. 18, 2010

(54) REGIONAL DEMAND AND SUPPLY COMPARISON

(75) Inventors: Wenyan Hu, Shanghai (CN); Qiang Wang, Shanghai (CN); Xiaoyuan Wu, Shanghai (CN); Alvaro Bolivar, San Francisco, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 12/551,408

(22) Filed: Aug. 31, 2009

Related U.S. Application Data
(63) Continuation-in-part of application No. 11/961,101, filed on Dec. 20, 2007.

(51) Int. Cl. G06Q 10/00; G06F 17/30

(52) U.S. Cl. 705/10; 707/769; 707/E17.014

(57) ABSTRACT

A computerized method and a system for comparing regional demand and supply are provided. Example embodiments may include receiving a criterion to identify an item and searching a database for data associated with demand and/or supply for the item identified by the criterion. The computerized method may also include presenting a geographic distribution of demand, supply, and/or net-demand for the item on a map. The map may display multiple geographic areas; each one of the multiple geographic areas may be displayed with a first and a second attribute. The first and the second attributes may be associated with the demand, supply, and/or the net-demand.

### RELATED APPLICATIONS

This application is a continuation-in-part of U.S. application Ser. No. 11/961,101, entitled “GEOGRAPHIC DEMAND DISTRIBUTION AND FORECAST,” filed Dec. 20, 2007, which is incorporated herein by reference in its entirety.

### TECHNICAL FIELD

Example embodiments relate generally to the technical field of data management, and in one specific example, to a system and a method for providing geographic demand distribution and forecast.

### BACKGROUND

More and more Internet users are realizing the ease and convenience of buying and selling online by way of person-to-person online trading. As a result, collectors, hobbyists, small dealers, unique item seekers, bargain hunters, and other consumers are able to buy and sell millions of items at various online commerce systems.

The success of an online commerce system depends upon its ability to provide an enjoyable shopping experience and an easy-to-use environment in which buyers and sellers may be able to close transactions with peace of mind. The online commerce systems may also benefit from providing buyers and sellers with transaction related information and statistics.

### BRIEF DESCRIPTION OF THE DRAWINGS

Some embodiments are illustrated by way of example and not limitation in the figures of the accompanying drawings in which:

FIG. 1 is a high-level diagram depicting an example embodiment of a system for regional demand and supply comparison;

FIG. 2 is a block diagram illustrating an example embodiment of a system for regional demand and supply comparison;

FIG. 3 is a high-level flow diagram illustrating an example method of comparing regional demand and supply;

FIG. 4 is a flow diagram illustrating an example method of comparing regional demand and supply;

FIG. 5 is high level block diagram illustrating an example embodiment of a network-based marketplace providing regional demand and supply comparison, having a client-server architecture;

FIG. 6 is block diagram illustrating an example embodiment of tables used by the databases of the network-based marketplace of FIG. 5;

FIG. 7 is an example set of marketplace and regional demand and supply applications used by the network-based marketplace of FIG. 5;

FIG. 8 is a block diagram illustrating a diagrammatic representation of a machine in the example form of a computer system;

FIG. 9 is a diagram illustrating in an example embodiment a map showing regional demand, supply, or net-demand distribution; and

FIG. 10 is a diagram illustrating in an example embodiment a map showing regional demand, supply, or net demand distribution and trends.

### DETAILED DESCRIPTION

Example methods and systems for providing regional demand and supply comparisons are described. In the following description, for purposes of explanation, numerous specific details are set forth in order to provide a thorough understanding of example embodiments. It will be evident, however, to one skilled in the art that the present embodiments may be practiced without these specific details.

Some example embodiments described herein may include receiving a criterion identifying an item and searching a database for data (e.g., geographic distribution data) relating to supply and/or demand for a type of item identified using the criterion. The method may also include presenting a geographic distribution of the demand, supply, and/or a net demand for the item on a map. The net-demand may comprise a surplus of the demand with respect to the supply for the item. The map may display multiple geographic areas; each one of the multiple geographic areas may be displayed with a first and a second attribute.

The first and the second attributes may be associated with the supply, demand, and/or the net-demand. In an example embodiment, receiving a criterion may comprise receiving a search query from a user of a commerce system. The search query may include keywords and logical constructs as is well known in the field of data retrieval. A commerce system database may be searched for supply and/or demand data associated with the type of item identified by the criterion. Hereafter, the word “item” may be used to refer to a set of items with similar characteristics, specifically, the characteristics identified by the search criterion.

The supply and/or demand data may be sorted based on geographic locations associated with the data. The sorted supply and/or demand data may be presented on a map with the map displaying multiple geographic areas. Each one of the multiple geographic areas may be displayed with a first and a second attribute relating to the sorted supply and/or demand data for the geographic area. The first attribute may indicate a level of the supply, demand, or the net-demand for the item, and the second attribute may indicate a trend for the supply, demand, or the net-demand for the item.

In a commerce system (e.g., EBAY INC. of San Jose, Calif.), the net-demand may be of particular interest for sellers of items. More specifically, sellers of large items may want to reduce their transportation cost by distributing these items based on the net-demand for that item. For example, a seller of sport utility vehicles (SUVs) on EBAY may have several depository stores in the United States. The seller may want to distribute the SUVs from the factory to depository stores based on net-demand for SUVs in the areas close to each depository store. Otherwise, the cost of redistribution from one depository store to another may be substantial, especially if those depository stores are quite far from each other. The seller may request regional net-demand data for SUV in the commerce system. The commerce system may compare regional demand and supply for SUV and provide regional net-demand data for the item as described in more detail below.

### Example System Architecture

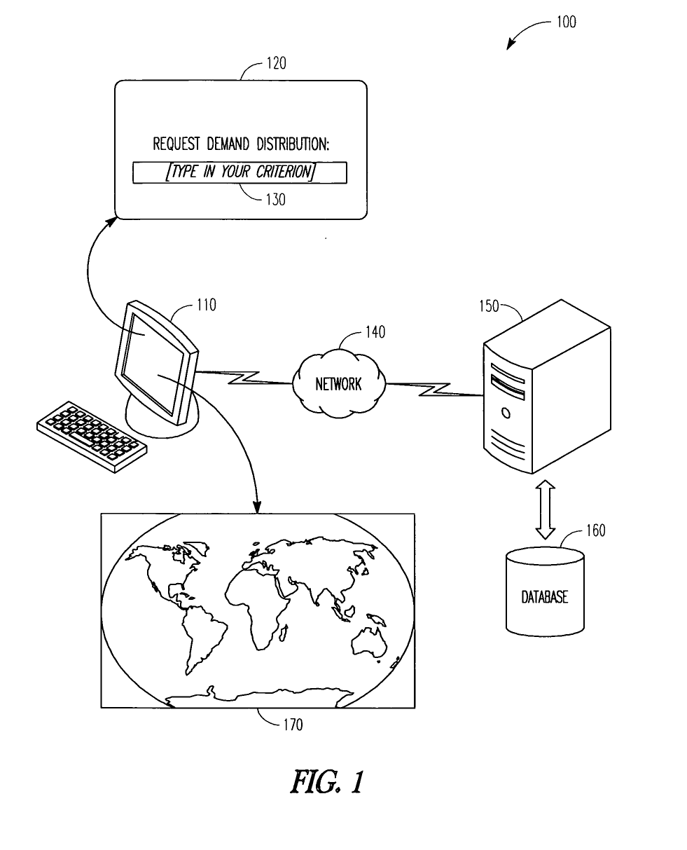

FIG. 1 is a high-level diagram depicting an example embodiment of a system 100 for regional demand and supply comparison. According to an example embodiment, using a client machine 110, a user may log into a Web page 120 of a commerce system to request a geographic net-demand distribution associated with an item (e.g., SUV). The user may enter a criterion to identify the item. In one embodiment, the user may enter a criterion by entering a search query in the query box 130 of the Web page 120. The commerce system server 150, coupled via a network 140 to the client machine 110, may receive the criterion.

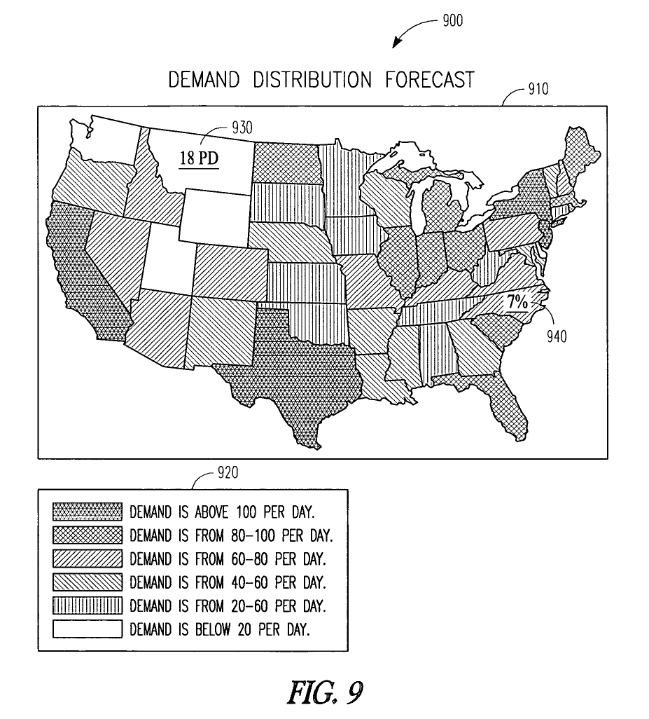

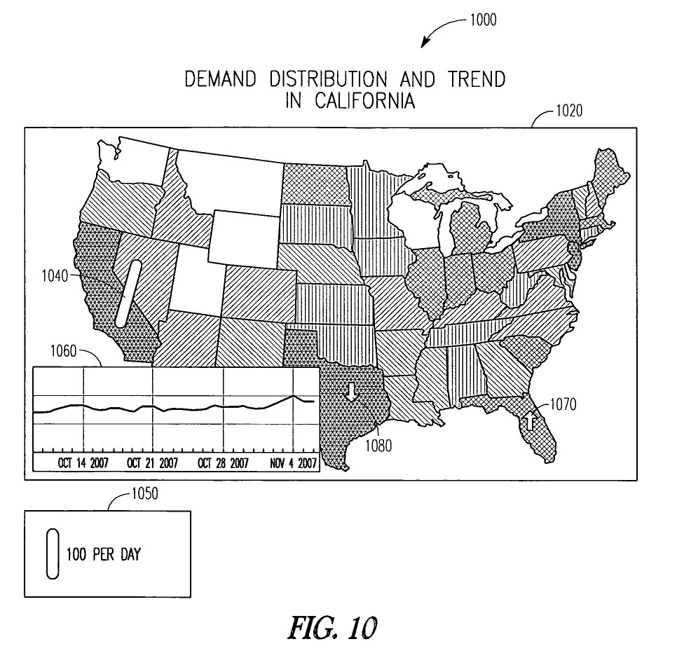

In example embodiments, the commerce system server 150 may use the criterion to search a database 160 for data associated with a geographic distribution of supply and/or demand for the item. The commerce system may present a geographic distribution of the supply and/or demand on a map 170. The map may be displayed with a first and a second attribute. The first and the second attributes may be associated with the item. The first attribute may include a level indicator, for example a color, as shown in FIG. 9. The color may depend on the demand level or the supply level for the item in each one of the geographic areas displaying the color. The level indicator may include a demand level indicator, a supply level indicator, or a net-demand indicator. The second attribute may include a trend indicator (e.g., an up or a down arrow, or a chart, as shown in FIG. 10).

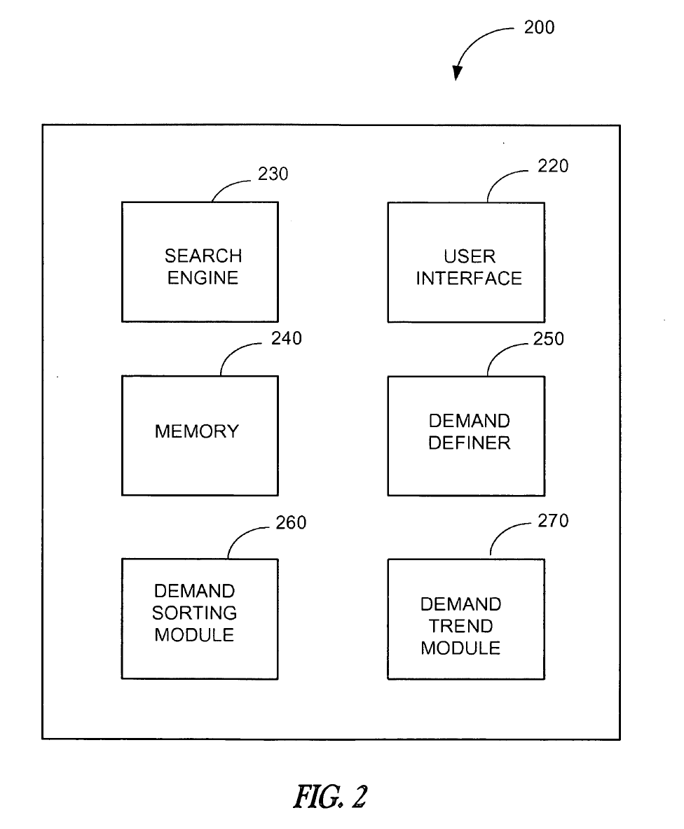

FIG. 2 is a block diagram illustrating an example embodiment of a system 200 for regional demand and supply comparison. The system 200 may include a user interface device 220, a processor 230, a memory 240, a search engine 250, a demand and supply definer 270, a demand and supply sorting module 260, and a demand and supply trend module 280.

According to example embodiments, the user interface device 220 may receive, via the network 140 from a Web page 120, a criterion entered by a user of a commerce system. The criterion may then be used by the search engine 250 to search the memory 240 for data associated with geographic demand and supply distributions for the item. In an example embodiment, the memory may include the database 160 or some distributed databases associated with the commerce system. The memory 240 may store the data associated with the geographic demand and supply distributions for the item.

In example embodiments, normal business operation of the commerce system may include recording information relating to all visitor events (e.g., search query, view, bids, completed auctions and BIN (Buy It Now) events) registered in the commerce system. The visitor event information may be associated with known visitor identification information that may include the name, address, phone number, and the like of the visitors to the commerce system Website. In cases where the visitor does not sign into the system, the site may be able to examine a cookie on the user's computer system to determine the visitor's identification information. The data recorded by the commerce system on the database 160 may also include listings for various items. The listings may include, inter alia, an address associated with the listing.

Returning to the search engine 250 functionality, the search engine 250 may search for one or more relevant listings of the commerce system that may match the item and fulfill the criterion entered by the user. The search engine 250 may then search the memory 240 for the statistics derived from listing logs of the commerce system, such as the visitor events information associated with the relevant listings. The retrieved visitor event information may be associated with the visitor location information of the visitors of the commerce system who contributed to the visitor events associated with the one or more relevant listings. The retrieved information may then be sorted by the demand and supply sorting module 260 to obtain the number of individual visitor events (e.g., search query, view, bid, BIN, and completed auctions) associated with the one or more relevant listings. For example, if the item is a laptop computer, the relevant listings may include the listings of all brands of notebook computers. For this example the total number of visitor events obtained for a specific geographical area may amount to: the number of searches (10,921), the number of views (3,560), the number of bids (1,264), the number of BINs (384), the number of completed auctions (734).

The number of visitor events found by the demand and supply sorting module 260 may not directly constitute the demand for the item in that geographical area. The demand and supply definer 270 may define the demand for the item as a function of an implicit and a satisfied demand. The implicit demand for an item may include the number of searches, bids, and views for relevant listings associated with that item. The satisfied demand for an item may be characterized by the total number of completed sales of relevant listings associated with that item. The completed sales may be from auctions (bid-based sales) or set price sales (BIN-based sales).

In an example embodiment, the demand and supply definer 270 may combine the implicit and satisfied demand for the item using predefined weights to obtain the demand for the item. For example, the demand may be defined by the following equation: demand=0.20 (implicit demand)+0.8 (satisfied demand). In one embodiment, this could be presented in greater detail as: demand=0.20 (searches+views+bids)+0.8 (completed auctions+completed BIN based sales).

In an alternative embodiment, the demand may be defined applying a more granular formula using the numbers associated with individual visitor events, each with a predefined weight. For example, the demand may be obtained from: demand=0.05 (number of searches)+0.15 (number of views)+0.10 (number of bids)+0.20 (number of auction sales)+0.5 (number of BIN based sales). The demands for relevant listings associated with the item calculated based on the formulas, such as the above formulas, may be stored in the memory 240.

The search engine 250 may also search the database 160 for statistics derived from listing logs of the commerce system such as listing addresses associated with the item. The listing addresses may identify geographic locations where the item may be available for sale. The demand and supply definer 270 may define a supply for the item based on the number of listings for the item. In an example embodiment the demand and supply definer 270 may define the supply for the item based on the number of listings for one or more items substantially similar to the item (e.g., performs similar function as the item does, has similar properties as the item has, may be applied for similar purposes as the item is, and so on).

The demand and supply definer 270 may compare the demand and supply and define a net-demand for the item as a surplus of the demand with respect to the supply for the item. For example, if the demand and supply for the item can be represented by 10,000 and 7,500, respectively, then the net-demand for the item may be determined as 2,500 (i.e., 10,000-7,500). Similarly, the demand and supply definer 270 may define net satisfied demand and a net implicit demand for the item, respectively, as a surplus of the satisfied demand and implicit demand with respect to the supply for the item. A negative number for a net-demand may be an indication that supply for the item is more than the demand. Demand, supply, and net-demand data may be sorted by the demand and supply sorting module 260 based on geographic locations associated with data. For example, the net-demand for an item in a specific location (e.g., a geographic area such as a country, a state, a county, a city, etc.) may be defined by using the demand and supply data for that location.

According to example embodiments, the user interface device 220 may present the geographical demand and supply distributions and demand and supply trends for the item on a map. The map may display different geographical areas with different colors. The color of each geographical area may represent the value of the demand, supply, and/or net-demand for the item in that area. Other attributes may also be used to distinguish different areas in terms of the demand, supply, and/or net-demand for the item in those areas. For example, the map may display a number on each area over the map to represent the magnitude of the demand, supply, and/or net-demand for the item in that area. The numbers may directly indicate the demand, supply, and/or net-demand magnitude(s) or be specified as a percentage of the total demand, supply, and/or net-demand. For example, the net-demand for laptop computers in California may be displayed as 12%. The 12% in this context may represent 12% of the total net-demand in the United States. The total net-demand for the United States may be displayed separately, e.g., under the map.

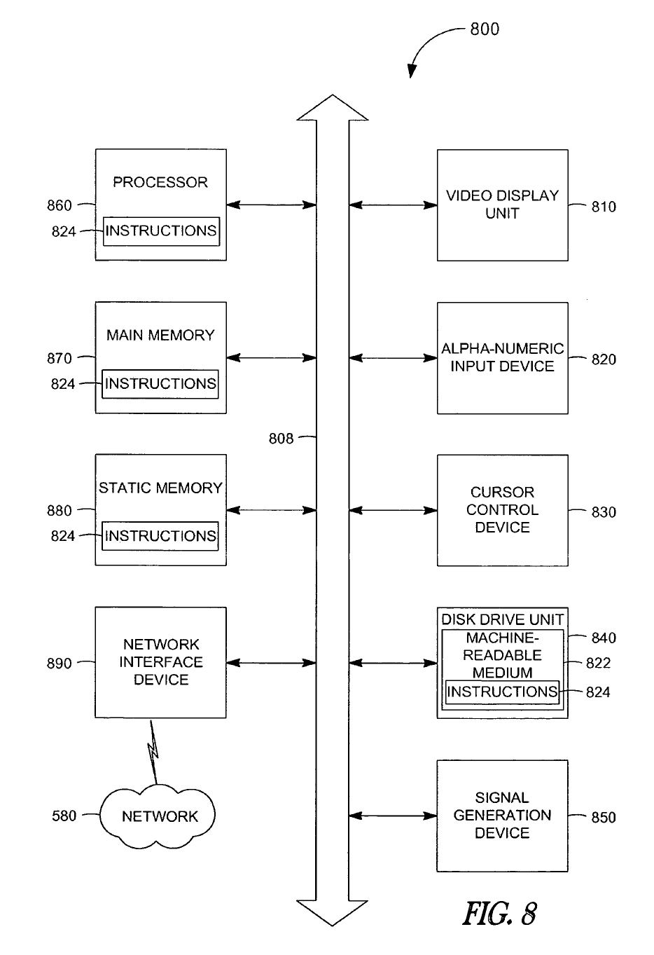

In example embodiments, the demand and supply trend module 280 may use the calculated demand, supply, and/or net-demand data for an item over time to obtain a demand, supply, and/or net-demand trend(s) (e.g., the chart shown in FIG. 10) for the item. The user interface device 220 may display, using the video display unit 810 shown in FIG. 8, the demand, supply, and/or net-demand trend(s) for the item as a time variation of demand, supply, and/or net-demand over a predefined period of time (see, for example, FIG. 10). The demand, supply, and/or net-demand trend(s) may also be displayed with up or down arrows on each geographical area on the map. The up arrow may indicate that present demand, supply, and/or net-demand for the item in that geographical area shows growth as compared to a demand, supply, and/or net-demand for the item in a predefined period of time or at a certain instance of time in the past. The down arrow may indicate that present demand, supply, and/or net-demand for the item in that geographical area shows a reduction as compared, respectively, to a demand, supply, and/or net-demand for the item in a predefined period of time in the past or on a certain date in the past.

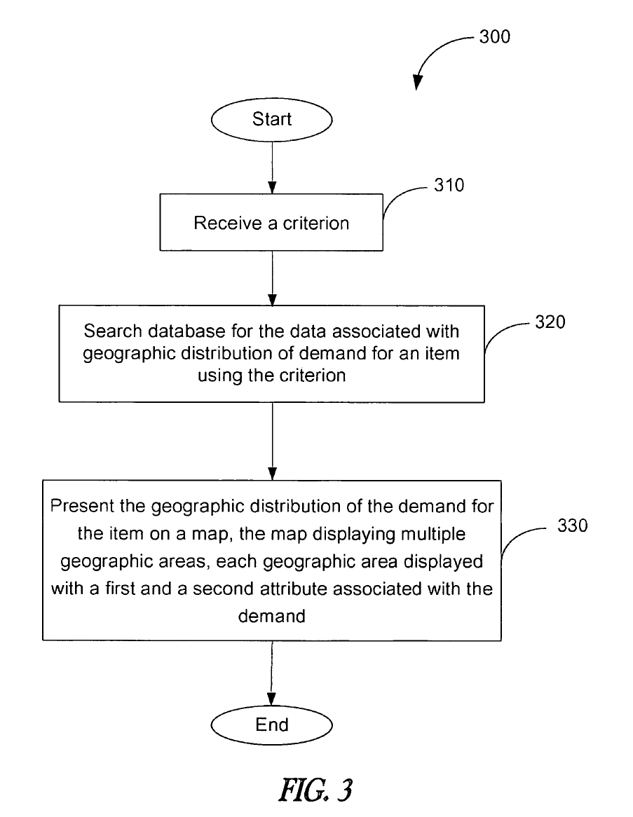

FIG. 3 is a high-level flow diagram illustrating an example method 300 for comparing regional demand and supply. The method may start at operation 310, where a criterion entered by a user of a commerce system may be received by the user interface device 220, via the network 140, from the Web page 120. The criterion may then be used at operation 320 by the search engine 250 to search the memory 240 for data associated with a geographic demand, supply, and/or net-demand distributions for the item. In an example embodiment, the memory 240 may include the database 160 or some other distributed databases associated with the commerce system. The memory 240 may store the data associated with the geographic demand and supply distributions for the item.

According to an example embodiment, the search engine 250 may search the memory for statistics derived from listing logs of the commerce system. The statistics may be relating to the implicit demand, the satisfied demand, and/or the supply for the item. The statistics derived from the listing logs of the commerce system may also include statistics associated with each of the multiple geographic areas shown on a map.

The geographic demand, supply, and/or net-demand distribution(s) may be defined by the demand and supply definer 270 based on the geographically sorted data prepared by the demand and supply sorting module 260 (for more details, refer to description of FIG. 2). At operation 330, the user interface device 220 may present the geographic demand, and/or the supply distribution(s) for the item on a map. The map may display multiple geographic areas. The user interface device 220 may display each geographic area with a first and a second attribute associated with the demand and/or the supply. For example, the first attribute may include a level indicator (e.g., a color, as shown in FIG. 9). The level indicator may comprise a demand level indicator, a supply level indicator, or a net-demand level indicator. The second attribute may include a trend indicator (e.g., an up or a down arrow or a chart as shown in FIG. 10).

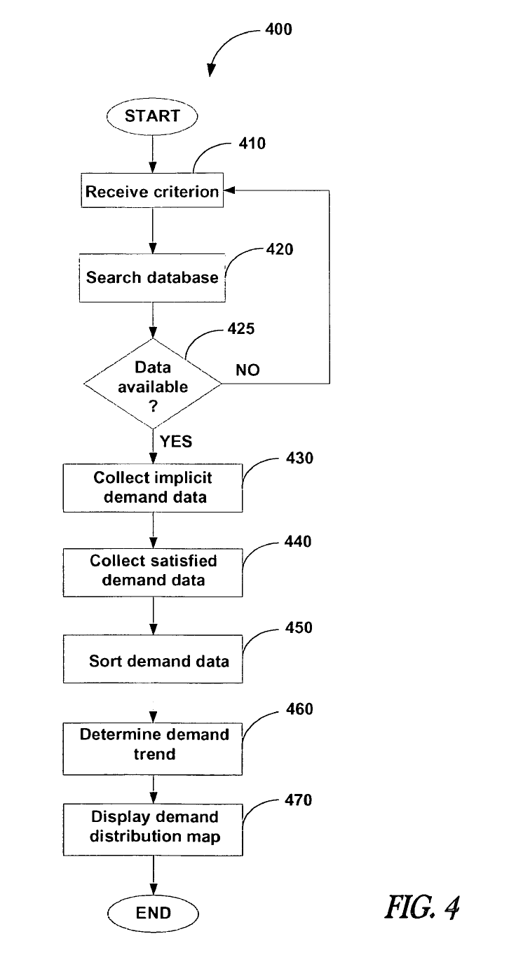

FIG. 4 is a flow diagram illustrating an example method 400 of comparing regional demand and supply. According to the method 400, at operation 410, the user interface device 220 may receive a criterion from a user of a commerce system. At operation 420, the search engine 250 may use the criterion to search the memory 240 for data relating to the listings associated with an item of interest to the user. The data may be relating to a demand and/or supply for the item. At control operation 425, if it is determined that the data relating to demand (i.e., demand data) for the item may not be available in memory 240, the control may be passed to a control operation 426. At the control operation 426, if it is determined that the data relating to the supply (i.e., supply data) for the item may not exist either in memory 240, the control is passed to operation 410, where a new criterion may be received from the user.

However, if control operation 426 indicates a positive result (meaning that the supply data is available), in a next step at operation 427, the demand and supply sorting module 260 may sort the supply data into geographically distributed data for each area of the map. The user may select the geographic areas for which the supply distribution is desired. At operation 428, the demand and supply trend module 280 may determine the supply trend for item. The supply trend may suggest how the present time supply compares with the supply in a predefined period of time in the past or on a certain date in the past.

According to example embodiments, at operation 429, the user interface device 220 may present a map displaying the geographic supply distribution. The level of supply for each area may be displayed with a color specific to that level. The supply trend may be displayed using a chart showing a time variation of the supply over a predefined time period. In an alternative example embodiment, the supply trend may be displayed with up/down arrows indicating up/down variation in the level of the supply for the item compared to a predefined period of time in the past or on a certain date in the past.

Returning to control operation 425, if this operation indicates a positive result (meaning that the demand data is available), at operation 430, the search engine 250 may search for and collect implicit demand data (e.g., data associated with the searches and views of the listings relating to the item). At operation 440, the search engine 250 may search for and collect satisfied demand data (e.g., data associated with bids and BINS on listings relating to the item). Next, at operation 442, the search engine 250 may search the memory 240 for supply data. If at control operation 445 it is determined that the supply data does not exist, the control is passed to operation 446.

At operation 446, the collected implicit and satisfied demand data may be sorted by the demand and supply sorting module 260 into geographically distributed data for each area of the map. The user may select the geographic areas for which the demand distribution is desired. The demand and supply definer 270 may define a demand equation, based on which a geographic demand for the item may be determined using the sorted implicit and satisfied demand data (as described above with respect to FIG. 2).

In an example embodiment, the demand and supply trend module 280 may be used at operation 447 to determine the demand trend for the item. The demand trend may suggest how the present time demand compares with the demand in a predefined period of time in the past or on a certain date in the past. According to example embodiments, at operation 448, the user interface device 220 may present a map displaying the geographic demand distribution. The level of demand for each area may be displayed with a color specific to that level. The demand trend may be displayed using a chart showing a time variation of the demand over a predefined time period. In an alternative example embodiment, the demand trend may be displayed with up/down arrows indicating up/down variation in the level of the demand for the item compared to a predefined period of time in the past or on a certain date in the past.

Returning to control operation 445, if the supply data does exist in the memory 240, at operation 450, the demand and supply definer 270 may determine the net demand for the item, using the demand and supply data. The user interface device 220 may present, at operation 460, a map displaying the geographic net-demand distribution. The level of net demand for each area may be displayed with a color specific to that level. The net-demand trend may also be displayed using a chart showing a time variation of the net demand over a predefined time period. In another example embodiment, the net-demand trend may be displayed with up/down arrows indicating up/down variation in the level of the net demand for the item compared to a predefined period of time in the past or on a certain date in the past.

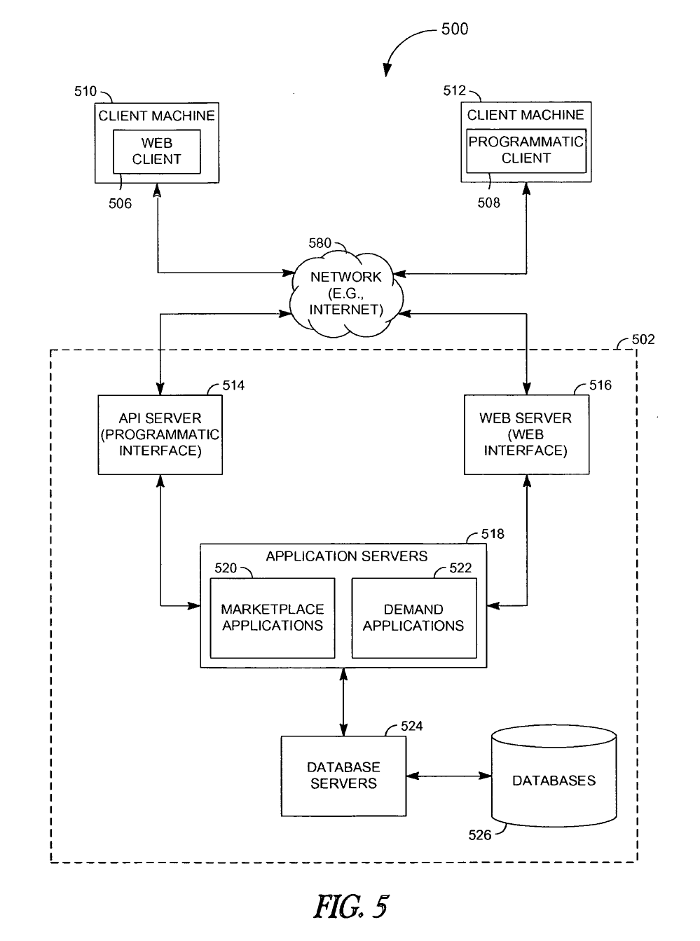

FIG. 5 is high-level block diagram illustrating an example embodiment of a network-based marketplace 500, providing regional demand and supply comparison and having a client-server architecture. A commerce platform, in the example form of a geographic demand and supply distribution forecasting server 502, provides server-side functionality, via a network 580 (e.g., the Internet) to one or more clients. FIG. 5 illustrates, for example, a Web client 506 (e.g., a browser, such as the INTERNET EXPLORER browser developed by Microsoft Corporation of Redmond, Wash.), and a programmatic client 508 executing on respective client machines 510 and 512.

Turning specifically to the geographic demand and supply distribution forecasting server 502, an Application Program Interface (API) server 514 and a Web server 516 are coupled to, and provide programmatic and Web interfaces respectively to, one or more application servers 518. The application servers 518 host one or more marketplace applications 520 and demand and supply applications 522. The application servers 518 are, in turn, shown to be coupled to one or more database servers 524 that facilitate access to one or more databases 526.

The marketplace applications 520 may provide a number of marketplace functions and services to users that access the network-based marketplace 500. The demand and supply applications 522 may use the data stored in the databases 526 to provide geographic demand distribution for an item, using a criterion received from the users.

Further, while the network-based marketplace 500 shown in FIG. 5 employs a client-server architecture, the disclosed system is, of course, not limited to such an architecture and could equally well find application in a distributed, or peer-to-peer, architecture system. The various marketplace and demand and supply applications 520 and 522 could also be implemented as standalone software programs, which do not necessarily have networking capabilities.

The Web client 506 may access the marketplace application 520 and demand and supply applications 522 via the Web interface supported by the Web server 516. Similarly, the programmatic client 508 may access the various services and functions provided by the marketplace application 520 and demand and supply applications 522, via the programmatic interface provided by the API server 514. The programmatic client 508 may, for example, be a demand search application to enable power sellers to obtain geographic distribution of demand for an item using the geographic demand and supply distribution forecasting server 502 in an off-line manner, and to perform batch-mode communications between the programmatic client 508 and the geographic demand and supply distribution forecasting server 502.

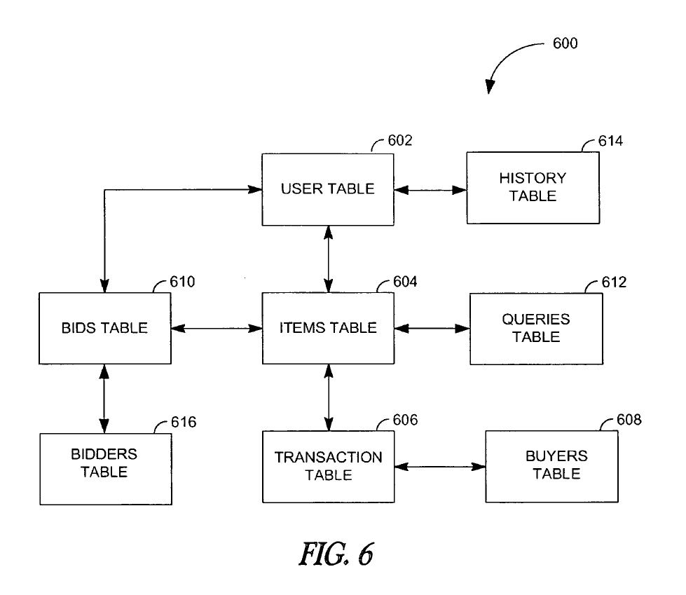

FIG. 6 is a high-level entity-relationship diagram, illustrating various tables 600 that may be maintained within the databases 526 that may be utilized by and support the geographic demand and supply distribution forecasting server 502. A user table 602 contains a record for each registered user of the network-based marketplace 500, and may include identifier, address and financial instrument information pertaining to each such registered user. A user may operate as a seller, a buyer, or both, in the network-based marketplace 500. In one example embodiment, a buyer may be a user that has accumulated value (e.g., commercial or proprietary currency), and may then be able to exchange the accumulated value for items that are offered for sale by the network-based marketplace 500.

The tables 600 also include an items table 604 in which may be maintained item records for goods and services that are available to be, or have been, transacted via the network-based marketplace 500. Each item record within the items table 604 may furthermore be linked to one or more user records within the user table 602, so as to associate a seller and one or more actual or potential buyers with each item record.

A transaction table 606 contains a record for each transaction (e.g., a purchase transaction) pertaining to items for which records exist within the items table 604.

A buyers table 608 is relating to the transaction tables 606; each record in the buyers table may be associated with a buyer in a purchase transaction. Each record may include the buyer's information such as a name, geographic location information, a purchased item, and a purchase amount.

Bid records within a bids table 610 each relate to a bid received at the geographic supply and demand distribution forecasting server 502 in connection with an auction-format listing supported by the network-based marketplace 500. A queries table 612 is utilized, in one example embodiment, to construct and maintain the list of items searched for by prospective buyers.

A history table 614 maintains a history of transactions to which a user has been a party. One or more bidders tables 616 record information pertaining to bidders of the bids for which records exist within the bids table 610. Each record of the bidders table may be associated with a bidder of a bid recorded in bids table 610. Each record of the bidders table 616 may include the bidder's information such as a name, geographic location information, an item bidded for, and a price of the item.

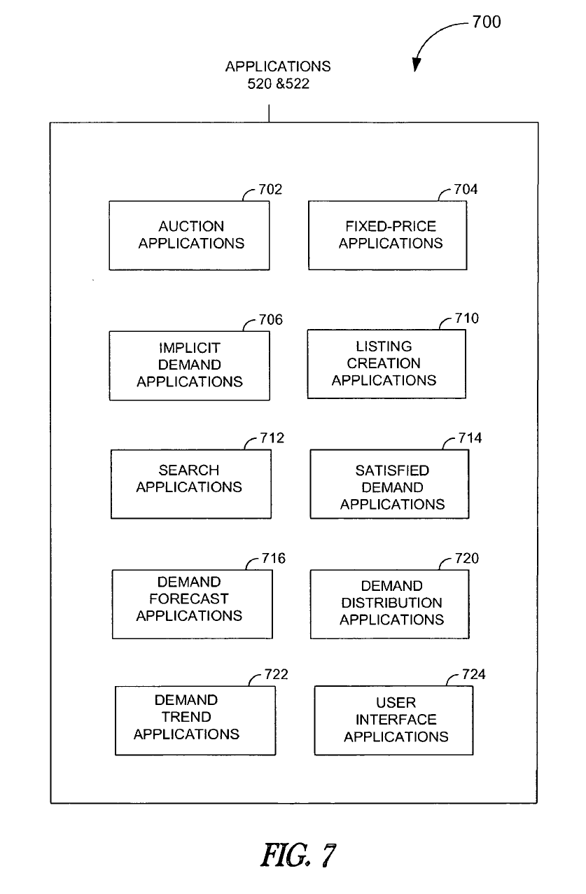

FIG. 7 illustrates an example set of marketplace and regional demand and supply applications 700 provided as part of the network-based commerce system of FIG. 5. The geographic supply and demand distribution forecasting server 502 may provide a number of marketplace applications 520, as well as demand and supply applications 522, whereby a user may request a geographic demand, supply, or net-demand distribution for an item relating to listings in the marketplace system.

The various auction applications 702 may provide a number of features in support of auction-format listings, such as a reserve price feature whereby a seller may specify a reserve price in connection with a listing and a proxy-bidding feature whereby a bidder may invoke automated proxy bidding.

A number of fixed-price applications 704 may support fixed-price listing formats (e.g., the traditional classified advertisement-type listing or a catalogue listing) and buyout-type listings. Specifically, buyout-type listings, e.g., BINs, may be offered in conjunction with an auction-format listing and allow a buyer to purchase goods or services, which are also being offered for sale via an auction, for a fixed-price that is typically higher than the starting price of the auction.

Listing creation applications 710 may allow sellers to conveniently author listings pertaining to goods or services that they wish to transact via the network-based marketplace 500. Implicit demand applications 706 may support collecting information on implicit demand including the number of searches and the number of views associated with listings relating to an item for which a geographic demand distribution is requested.

A number of search applications 712 may support searching the databases 526 of the network-based marketplace 500 for geographical demand and/or supply distribution(s) for an item, using a criterion received from a user of the network-based marketplace 500. Satisfied demand applications 714 may support collecting information on satisfied demand including the number of bids and BINs and the dollar amounts corresponding to the bids and BINs associated with listings relating to an item for which a geographic demand and/or supply distribution(s) is requested.

Demand forecast applications 716 may provide one or more demand equations. The demand equations may be used to define a demand based on the implicit demand and the satisfied demand data collected by the implicit demand applications 706 and the satisfied demand applications 714. In example embodiments, the demand equation may define the demand for an item based on components of the implicit demand and the satisfied demand (e.g., number of searches, views, bids and BINs) for that item.

Demand distribution applications 720 may use the geographic location information associated with various users of the network-based marketplace 500 to provide a geographic demand distribution for an item. The geographic location information may be associated with searches or views of certain listings relating to the item or with the number of bids and BINs on those listings. The demand distribution applications 720 may store the geographic demand distribution for the item in the databases 526 of FIG. 5.

Demand trend applications 722 may provide a trend for the demand of an item over time. The demand trend applications 722 may retrieve the geographic demand distribution for various geographic areas from the databases 526 at various time intervals and construct the demand trend based on the time variations of the demand or by comparing the present demand with the demand in a predefined time period in the past or on a predefined past date.

Supply trend applications 724 may provide a trend for the supply of an item over time. The supply trend applications 724 may retrieve the geographic supply distribution for various geographic areas from the databases 526 at various time intervals and construct the supply trend based on the time variations of the supply or by comparing the present supply with the supply in a predefined time period in the past or on a predefined past date.

Net-demand distribution applications 726 may use the geographic location information associated with various users of the network-based marketplace 500 to provide a geographic net-demand distribution for an item. The net-demand distribution applications 726 may determine net-demand for each area by comparing the demand and supply data for that area and determining the net-demand as a surplus of demand with respect to supply for the item in that area. The net-demand distribution applications 726 may store the geographic net-demand distribution for the item in the databases 526 of FIG. 5.

User interface applications 728 may provide support for presenting the geographical demand, supply, and/or net-demand distribution(s) and the demand, supply, and/or net-demand trend(s) for the item on a map. The map may display different geographical areas (e.g., countries, states, counties, cities, etc.) with different colors. The color of each geographical area may represent the level of the demand, supply, and/or net-demand for the item in that area. The user interface applications 728 may display the demand, supply, and/or net-demand trend(s) for the item as a time variation of demand over a predefined period of time (see, for example, FIG. 10).

In an example embodiment, the demand, supply, and/or net-demand trend(s) may also be displayed with up or down arrows on each geographical area on the map. The up arrow may indicate that present demand, supply, and/or net-demand for the item in that geographical area shows growth as compared to a respective demand, supply, and/or net-demand for the item in a predefined period of time or at a certain instance of time in the past. The down arrow may indicate that present demand, supply, and/or net-demand for the item in that geographical area shows a reduction as compared to a respective demand, supply, and/or net-demand for the item in a predefined period of time or at a certain instance of time in the past.

### Machine Architecture

FIG. 8 is a block diagram illustrating a diagrammatic representation of machine 800 in the example form of a computer system within which a set of instructions for causing the machine to perform any one or more of the methodologies discussed herein may be executed. In alternative embodiments, the machine 800 may operate as a standalone device or may be connected (e.g., networked) to other machines. In a networked deployment, the machine 800 may operate in the capacity of a server or a client machine in a server-client network environment, or as a peer machine in a peer-to-peer (or distributed) network environment.

The machine 800 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 may include a processor 860 (e.g., a central processing unit (CPU), a graphics processing unit (GPU) or both), a main memory 870 and a static memory 880, all of which communicate with each other via a bus 808. The computer system 800 may further include a video display unit 810 (e.g., a liquid crystal display (LCD) or cathode ray tube (CRT)). The computer system 800 also may include an alphanumeric input device 820 (e.g., a keyboard), a cursor control device 830 (e.g., a mouse), a disk drive unit 840, a signal generation device 850 (e.g., a speaker) and a network interface device 890.

The disk drive unit 840 may include a machine-readable medium 822 on which is stored one or more sets of instructions (e.g., software) 824 embodying any one or more of the methodologies or functions described herein. The software 824 may also reside, completely or at least partially, within the main memory 870 and/or within the processor 860 during execution thereof by the computer system 800, with the main memory 870 and the processor 860 also constituting machine-readable media. The software 824 may further be transmitted or received over a network 580 via the network interface device 890.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions 824. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories and optical and magnetic media.

FIG. 9 is a diagram illustrating in an example embodiment showing regional demand, supply, or net-demand distribution 900. The example regional demand, supply, or net-demand distribution 900 is associated with the listings on a commerce system relating to an item. In the example of FIG. 9, the demand, supply, or net-demand is divided into the different states of the United States of America. However, other embodiments could use other geographic areas such as postal ZIP codes, telephone area codes, or countries on a world or continent map.

The regional demand, supply, or net-demand distribution 900 is shown on a map 910 of the United States, where the demand, supply, or net-demand for the item in each state is displayed with a specific symbol (e.g., gray scale, color or the like). Legend 920 provides keys for symbols of the map 910 defined in terms of various levels of demand, supply, or net-demand for the item. For example, the darkest gray scale may indicate that the level of demand, supply, or net-demand for the item is above 100 units per day. The net demand, as described above, may be determined using the demand and supply data. The demand may be defined based on the number of searches, views, bids and BINS for the listings relating to the item in the commerce system.

In another example embodiment, the demand, supply, or net-demand level in a geographic area may be represented with a demand, supply, or net-demand level indicator number(s) 930 displayed on the map. For example, the net-demand level indicator number 930 shows the net-demand for the item in Montana to be 18 per day. In alternative example embodiments, the demand, supply, or net-demand may be shown per different time units such as per week, per month, per year, etc. In yet another example embodiment, the demand, supply, or net-demand in each area may be displayed as a percentage of the respective total demand, supply, or net-demand in all areas shown on the map 910. For example, the net-demand indicator 940 shows that net-demand in North Carolina may be 7% of the national net-demand.

FIG. 10 is a diagram illustrating in an example embodiment a map showing regional demand, supply, or net-demand distribution and trends 1000. The demand, supply, or net-demand distribution for an item is shown on the map 1020. Specifically, the bar 1040 is used to indicate the demand, supply, or net-demand level for the item in Los Angeles. A guide 1050 may assist users in estimating the demand level from the height of the bar. For example, the bar 1040, estimably, indicates 150 items per day for Los Angeles.

Also shown in FIG. 10 is a trend 1060 for the item illustrated as a time variation of the demand, supply, or net-demand for the item. The trend may be associated with the total demand, supply, or net-demand for the United States or a specific state. In an alternative example embodiment, the trend may be depicted with a trend indicator, such as up or down arrows 1070 and 1080. The up or down arrows 1070 and 1080 may represent growth or a reduction in status of the present demand, supply, or net-demand for the item compared to a predefined period of time in the past or on a certain date in the past.

Thus, a method and a system for providing regional demand and supply comparison have been described. Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computerized method comprising:
receiving, at a server computer, a criterion, the criterion identifying an item;
searching a database for at least one of demand or supply data relating to the item identified by the criterion; and
presenting, on a map to be displayed on a display device, a geographic distribution of the at least one of demand, supply, or a net-demand, derived based on the demand or supply data, for the item, the map to display a plurality of geographic areas, each of the plurality of geographic areas to be displayed with at least one of a first or a second attribute, the first and the second attributes relating to at least one of the demand, supply, or net-demand for the item.

2. The computerized method of claim 1, wherein the receiving of the criterion includes receiving the criterion over a network from a seller associated with a commerce system.

3. The computerized method of claim 1, wherein the supply is derived from a number of listings associated with at least one of the item or one or more items substantially similar to the item.

4. The computerized method of claim 1, wherein the presenting of the geographic distribution occurs responsive to the searching of the database delivering a positive result.

5. The computerized method of claim 1, wherein the searching of the database comprises searching a commerce system database including statistics derived from listing logs of a commerce system, the statistics relating to at least one of: an implicit demand, a satisfied demand, or the supply for the item.

6. The computerized method of claim 5, wherein the implicit demand is derived from a number of searches and views of the item, and the satisfied demand is derived from at least one of: purchasing amounts associated with bids, or purchasing amounts associated with fixed price purchases.

7. The computerized method of claim 5, wherein the statistics derived from the listing logs of the commerce system include statistics associated with each of the plurality of geographic areas.

8. The computerized method of claim 5, including defining the demand for the item as a function of the implicit demand and the satisfied demand for the item.

9. The computerized method of claim 5, including defining a net satisfied demand for the item as a surplus of the satisfied demand with respect to the supply for the item.

10. The computerized method of claim 5, including defining a net implicit demand for the item as a surplus of the implicit demand with respect to the supply for the item.

11. The computerized method of claim 1, including defining a net-demand for the item as a surplus of the demand with respect to the supply for the item.

12. The computerized method of claim 1, wherein the first attribute comprises a level indicator including at least one of a demand level indicator, a supply level indicator, or a net-demand indicator.

13. The computerized method of claim 12, wherein the level indicator includes a color, and wherein the color depends on a level of at least one of the demand, the supply, or the net-demand for the item in each one of the geographic areas displaying the color.

14. The computerized method of claim 12, wherein the first attribute includes a number, the number being an indicator of at least one of the demand, the supply, or the net-demand for the item in each one of the geographic areas displaying the number.

15. The computerized method of claim 1, wherein the second attribute includes a trend indicator.

16. The computerized method of claim 15, wherein the trend indicator displays an up or a down trend in at least one of a present demand, supply, or net-demand for the item as compared with at least one of a demand, supply, or net-demand, respectively, at a predefined past date.

17. The computerized method of claim 15, wherein the trend indicator includes an up or a down arrow indicating an up or a down trend.

18. A system comprising:
an interface device to receive a criterion, the criterion identifying an item;
memory to store data relating to at least one of a demand or a supply for the item identified by the criterion;
a processor-implemented search engine to search the data stored in the memory; and
the interface device to present, on a map, a geographic distribution of at least one of the demand, the supply, or a net-demand, derived based on the data for the item, the map to display a plurality of geographic areas, each one of the plurality of geographic areas to be displayed with a first and a second attribute, the first and the second attributes being associated with at least one of the demand, the supply, or the net-demand for the item.

19. The system of claim 18, wherein the interface device is to receive the criterion over a network from a seller associated with a commerce system.

20. The system of claim 18, wherein the processor-implement search engine is to search a commerce system database including statistics derived from listing logs of a commerce system, the statistics being relating to at least one of: an implicit demand, a satisfied demand, or a supply.

21. The system of claim 18, including a processor-implemented supply definer module to define the supply based on a number of listings associated with at least one of the item or one or more items substantially similar to the item.

22. The system of claim 20, including a processor-implemented demand definer module to define the demand for the item as a function of the implicit demand and the satisfied demand for the item.

23. The system of claim 18, including a processor-implemented net-demand definer module to define the net-demand as a surplus of the demand with respect to the supply for the item.

24. The system of claim 18, wherein the interface device is to facilitate display of the first attribute, the first attribute including a level indicator indicating a level of at least one of the demand, supply, or net demand for the item.

25. The system of claim 18, wherein the interface device is to facilitate display of the second attribute, the second attribute including a trend indicator.

26. A system comprising:
means for receiving a criterion, the criterion identifying an item;
means for searching a database for data relating to at least one of a demand or a supply for the item identified by the criterion; and
means for presenting, on a map, a geographic distribution of at least one of the demand, the supply, or a net-demand, derived based on the data, for the item, the map to display a plurality of geographic areas, each one of the plurality of geographic areas to be displayed with a first and a second attribute, the first and the second attributes being associated with at least one of the demand, the supply, or the net-demand for the item.

27. A machine-readable medium comprising instructions, which when implemented by one or more processors perform following operations:
receiving a criterion, the criterion identifying an item;
searching a database for data relating to at least one of a demand or supply for the item identified by the criterion; and
presenting on a map a geographic distribution of at least one of the demand, supply, or a net-demand, derived based on the data, for the item, the map displaying a plurality of geographic areas, each one of the plurality of geographic areas being displayed with a first and a second attribute, the first and the second attributes being associated with at least one of the demand, supply, or net-demand for the item.

28. A computerized method comprising:
receiving a query from a user of a commerce system, the query including a criterion identifying an item;
searching a commerce system database for first data relating to at least one of a demand or supply for the item identified by the criterion;
deriving second data relating to a net-demand based on the first data;
sorting the first and second data based on geographic locations associated with the first and second data; and
presenting at least some of the sorted first and second data on a map, the map displaying a plurality of geographic areas, at least some of the plurality of geographic areas being displayed with a first and a second attribute relating to the at least some of the sorted first and second data, the first attribute indicating a level and the second attribute indicating an up or a down trend.
